(19) United States
(12) Patent Application Publication
(10) Pub. No.: US 2005/0113554 A1
(43) Pub. Date: May 26, 2005

(54) Hyperbranched polymers

(76) Inventor: Lance James Twyman, Fulwood (GB)

Correspondence Address: FISH & RICHARDSON PC, 225 FRANKLIN ST, BOSTON, MA, 02110, US

(21) Appl. No.: 10/738,923

(22) Filed: Dec. 16, 2003

(30) Foreign Application Priority Data
Nov. 21, 2003 (GB) GB 0327135.0

(51) Int. Cl. C08G 63/02

(52) U.S. Cl. 528/272

(57) ABSTRACT

A water-soluble hyperbranched polymer comprising a porphyrin moiety and one or more hyperbranched polymer chains covalently bound thereto. The polymer when metalated with an Fe(II) ion is capable of mimicking the oxygen binding properties of blood. The polymer may be used as a haemoglobin replacement, in synthetic blood products and as a blood substitute.

This invention relates to hyperbranched polymers, and more particularly to a hyperbranched polymer comprising a porphyrin moiety.

hyperbranched polymers (polymers containing two or more generations of branching) are well known. The formation of high molecular weight hyperbranched polymers from AB₂ monomers containing one group of type A and two of type B was first described in U.S. Pat. No. 4,857,630. Numerous other hyperbranched polymers have been reported since that time, for example, by Hawker et al, J. Am. Chem. Soc. 113, 4252-4261 (1991); Turner et al, Macromolecules, 27, 1611 (1994); and in U.S. Pat. Nos. 5,196,502, 5,225,522 and 5,214,122. All of these hyperbranched polymers were obtained by polycondensation processes involving AB₂ monomers.

Topologically, hyperbranched polymers have at least two branching points and one focal point unit or core clearly distinguishable from the end groups. The focal point or core is generally the site of the initiation of the polymerisation. Known hyperbranched polymers have irregularly branched structures with high degrees of branching between 0.2 and 0.8. The degree of branching DB of an AB₂ hyperbranched polymer has been defined by the equation DB=(1−f) in which f is the mole fraction of AB₂ monomer units in which only one of the two B groups has reacted with an A group.

Porphyrins occur widely in nature, and perform very important roles in various biological processes. The chemical structure of porphyrin is shown in Formula 1.

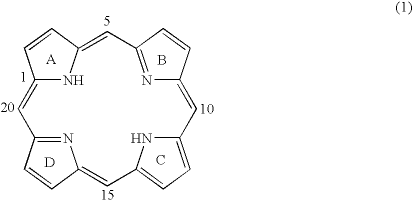

The basic structure of a porphyrin consists of four pyrrole units linked by four methine bridges. A feature of porphyrins is their ability to be metalated and demetalated. A number of metals (e.g. Fe, Zn, Cu, Ni) can be inserted into the porphyrin cavity by using various metal salts. Removal of the metal (demetalation) can be achieved, for example, by acid treatment.

Porphyrin can be synthesised by a variety of methods, for example, by tetramerisation of monopyrroles, by condensation of dipyrrolic intermediates, or by cyclization of open-chain tetrapyrroles.

Haem (the iron(II) protoporphyrin-IX complex) is the prosthetic group in haemoglobins and myoglobins, which are molecules responsible for dioxygen transport and storage in living tissues. Its chemical structure is shown in Formula 2.

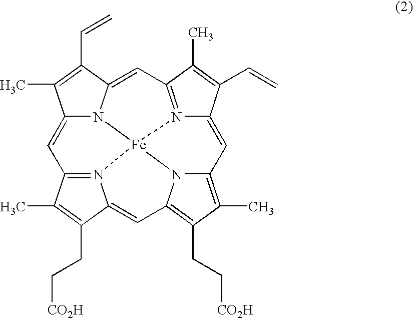

Haemoglobin contains four protein subunits, each possessing a porphyrin moiety in their “active site”. An iron (II) atom is located in the centre of each porphyrin moiety and it is this that reversibly binds dioxygen. An important role of the protein backbone is to protect and isolate the porphyrin active site within a hydrophobic environment.

Haem can also be found in the enzyme peroxidase, which catalyzes the oxidation of substrates with hydrogen peroxide. The related enzyme catalase, also containing haem, catalyzes the breakdown of hydrogen peroxide to water and oxygen. Other haem-containing proteins include the cytochromes, which serve as one-electron carriers in the electron transport chain.

Reduction of one of the pyrrole units on the porphyrin ring leads to a class of porphyrin derivatives called chlorins. Chlorophylls, found abundantly in green plants, belong to this category, and play an important role in the process of photosynthesis.

Recently, attempts have been made to prepare covalently linked multiporphyrin arrays, and to use such systems in artificial photosynthesis. The incorporation of porphyrin moieties into the framework of a dendrimer has been described by Jiang and Aida, J. Macromol. Sci, Pure Appl. Chem., 1997,A34,2047 and by Weyermann and Diederich J. Chem, Soc., Perkins Trans. 1, 2000, 4231-4233. The main drawback of dendrimers is that they have to be constructed by a multi-step synthesis, which is both lengthy and costly.

Hyperbranched aliphatic polyether polymers containing multiple porphyrin moieties have been described by Hecht et al in Chem. Commun., 2000, 313-314. These polymers have been suggested for use in photophysical and electrochemical studies, and for the construction of optoelectronic devices, but they are of limited use in biological systems because of their bio-incompatibility and relative insolubility in biological media.

According to the present invention there is provided a water-soluble hyperbranched polymer comprising a porphyrin moiety.

In a first aspect, the present invention provides a water-soluble hyperbranched polymer comprising a porphyrin moiety and one or more hyperbranched polymer chains covalently bound thereto.

Preferably the porphyrin moiety is a focal core of the polymer and is surrounded by up to four hyperbranched polymer chains covalently bound thereto.

In a second aspect the invention provides a process for the production of a water-soluble hyperbranched polymer comprising one or more porphyrin moieties, which process comprises subjecting an AB₂ monomer to a polymerisation reaction in the presence of a functionalised porphyrin or porphyrin derivative as a polymerisation initiator core.

In a further aspect, the invention provides a water-soluble hyperbranched polymer comprising a porphyrin moiety having an Fe (II) atom inserted therein.

In a yet further aspect the invention provides a synthetic blood product which comprises an aqueous solution of a water-soluble hyperbranched polymer comprising a porphyrin moiety having an Fe (II) atom inserted therein capable of reversibly binding oxygen thereto.

Hyperbranched polymers of the present invention preferably have the structure:
P(HB)ₙ (3)
where P is a porphyrin moiety as hereinafter defined, HB is a hyperbranched polymer chain and n is an integer of from 1 to 4.

By “water-soluble” in this specification is meant that the hyperbranched polymers are soluble in water at least to the extent of 1 g/l, more preferably at least 50 g/l, most preferably at least 100 g/l. The hyperbranched polymers of the present invention may be water-soluble, for example, due to the presence of solubilising substituents in the polymer chains. Neutral hydroxyl groups are particularly effective as solubilising substituents, although groups such as amine, acid, quaternary ammonium and other similar groups can also be used. The water-soluble polymer chains can, of course, comprise several different solubilising substituents. The solubilising substituents can be derived from the monomeric component(s) of the hyperbranched polymer chains, or can be introduced by substitution reactions.

The hyperbranched polymer chains can be, for example, polyethers, polyesters, and polyamides. Polyglycerols and other hydroxyl-substituted polyethers, are particularly preferred.

Where the hyperbranched polymer is a polyether, it can be derived from the polymerisation of AB₂ monomers such as, for example, 2-(bromomethyl)-2-methylpropane-1,3-diol (or derivatives thereof).

Where the hyperbranched polymer is a polyester, it can be derived from the polymerisation of AB₂ monomers such as, for example, 2,2-bis(hydroxymethyl)butanoic acid, and 3-hydroxy-2-(hydroxymethyl)-2-methylpropanoic acid.

Latent AB₂ monomers, wherein the monomer polymerises by ring opening polymerisation are especially preferred. Preferred examples of latent AB₂ monomers include glycidol(2,3-epoxy-I-propanol), 2,3-epoxy-I-butanol, 2,3-epoxy-I-pentanol, and 4-(2-hydroxyethyl)-ε-caprolactone (and simple derivatives thereof).

The polymerisation reaction can be carried out, for example, under reflux in an organic solvent, preferably at a temperature of from 40 to 180° C.

The hyperbranched polymer chains covalently linked to the porphyrin moiety preferably are of a size, shape and number sufficient to provide a hydrophobic region around the porphyrin moiety, to protect and isolate the porphyrin moiety. This is particularly important where the porphyrin moiety comprises an inserted ferrous ion, in order to reduce the rate of oxidation (and hence inactivation) of the ferrous ion. Preferably there are four hyperbranched polymer chains covalently linked to the porphyrin moiety for maximum protection. The hyperbranched polymers of the invention preferably have a molecular weight within the range of from 1000 to 10,000, more preferably from 4000 to 7000, most preferably from 5000 to 6000. The hyperbranched polymers preferably have a polydispersity of from 1.1 to 3.0.

By “a porphyrin moiety” in this specification is meant a moiety having a basic structure of four linked pyrrole units, and derivatives thereof, including porphyrin (Formula I); alkyl substituted porphyrins, for example, C₁₋₆ tetra(hydroxylalkyl) substituted porphyrins; aryl substituted porphyrins, for example, tetraphenol porphyrin; metalated derivatives of porphyrin, for example, iron(II) protoporphyrin-IX complexes (Formula 2); reduction products of porphyrin, for example, chlorin (Formula 3); 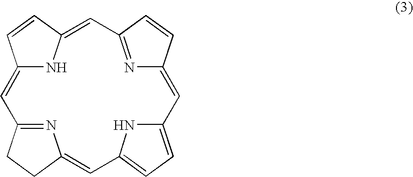
reduction products of chlorins in which the reduced pyrrole units are diagonally opposite to each other, for example, bacteriochlorins (Formula 4); 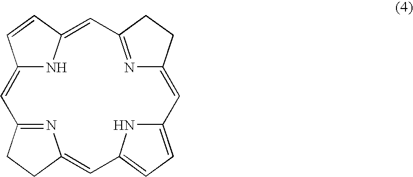
and porphyrin-like moieties such as corrin (Formula 5); 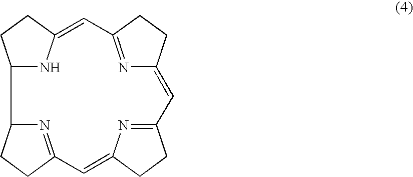
and corrole (Formula 6).

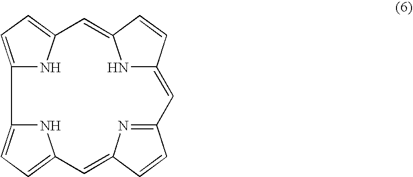

The functionalised porphyrin or porphyrin derivative is one that is capable of initiating the polymerisation of an AB₂ monomer and of forming a covalent bond with the growing hyperbranched polymer. The functional groups can be any of those capable of reacting with an AB₂ monomer, including hydroxyalkyl groups, hydroxyaryl groups, acid groups, amine groups, epoxy and ester groups. Functional groups can be introduced at any convenient location on the ring of the porphyrin or porphyrin derivative, provided that they do not inactivate the porphyrin. Thus substitutions can be made in the pyrrole rings or in the methine bridging groups as appropriate. Up to eight functional groups capable of initiating the polymerisation of an AB₂ monomer and of forming a covalent bond with the growing hyperbranched polymer can be introduced although four are often sufficient. Preferred functionalised porphyrin and porphyrin derivatives include especially 5, 10, 15, 20-substituted porphyrins, particularly 5, 10, 15, 20-hydroxyaryl substituted porphyrins, for example, 5, 10, 15, 20-tetraphenol porphyrin and 5, 10, 15, 20-tetra(dihydroxyphenyl) porphyrin. Such compounds can be activated to become polymerisation initiators, for example, by reaction with a deprotonating agent such as, for example, sodium hydride.

By “a focal core” in this specification is meant a region from which the hyperbranched polymer chains appear to radiate. In a preferred process according to the invention, a functionalised porphyrin or derivative is reacted with an AB₂ monomer under polymerisation conditions such that the AB₂ monomer polymerises to form hyperbranched polymer chains radiating from the porphyrin moiety which occupies the centre or core of the polymer molecule. An example of a polymerisation reaction according to the invention, using glycidol as the latent AB₂ monomer and 5, 10, 15, 20-tetraphenol porphyrin as the reaction initiator, is illustrated in reaction scheme I:

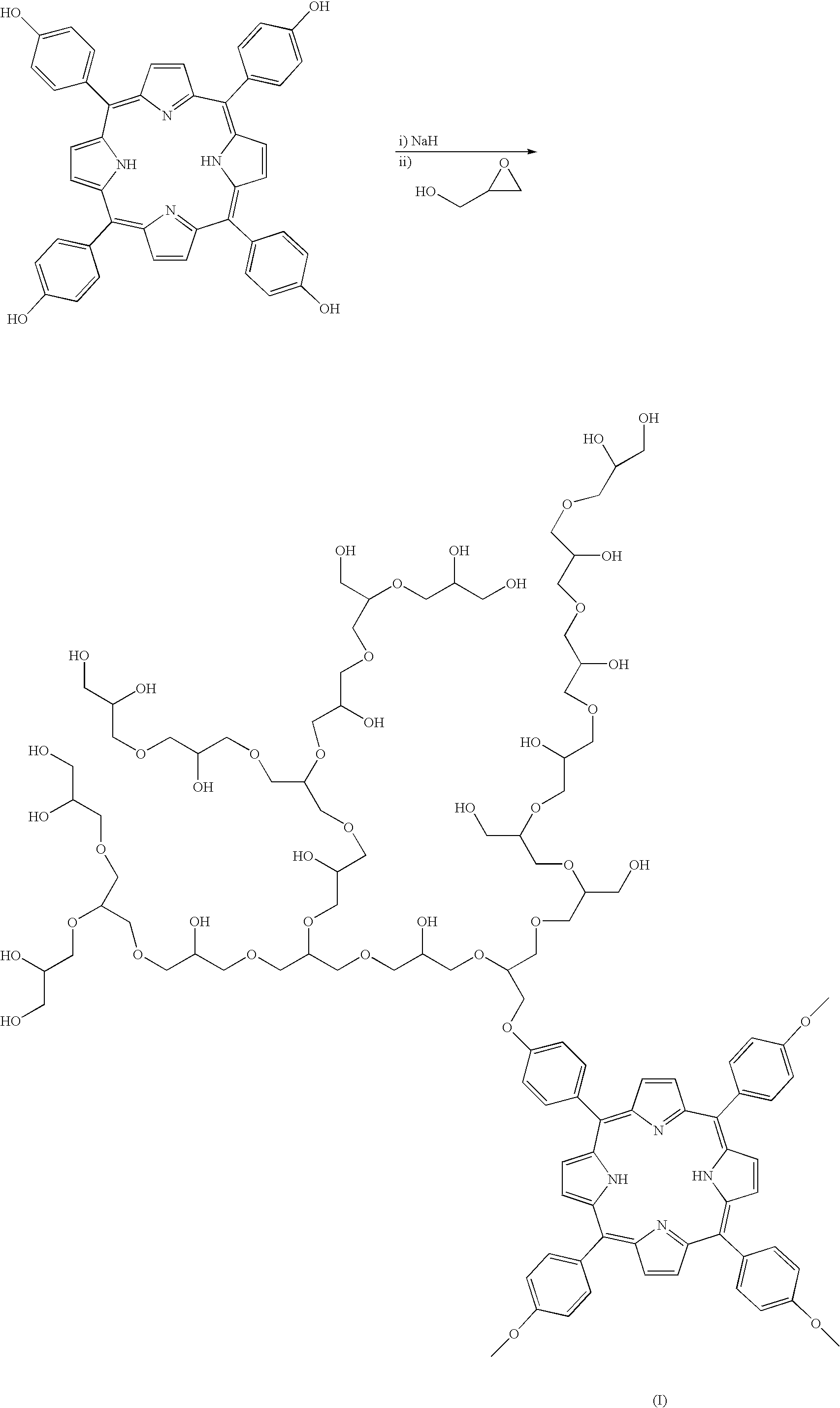

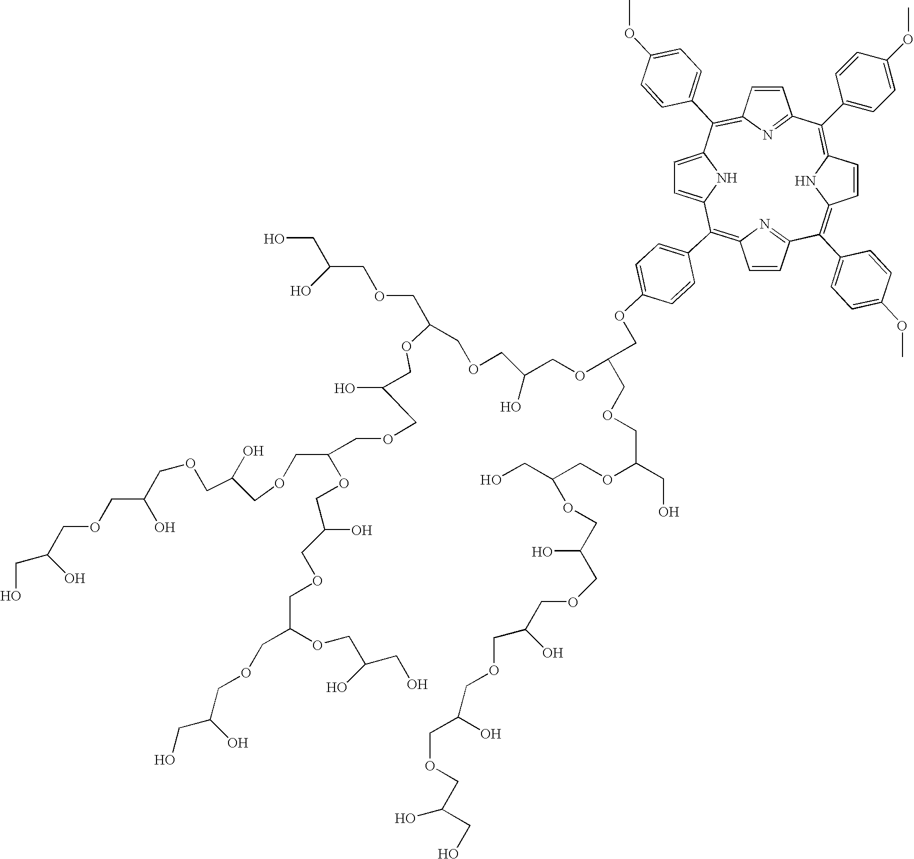

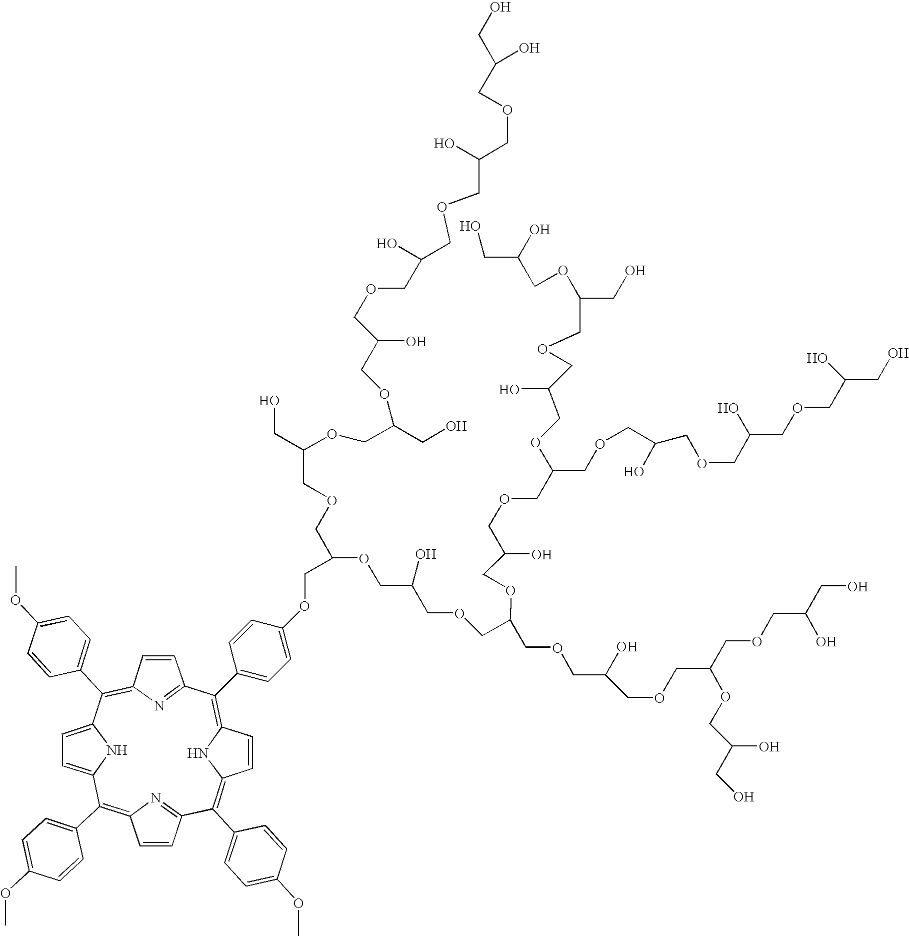

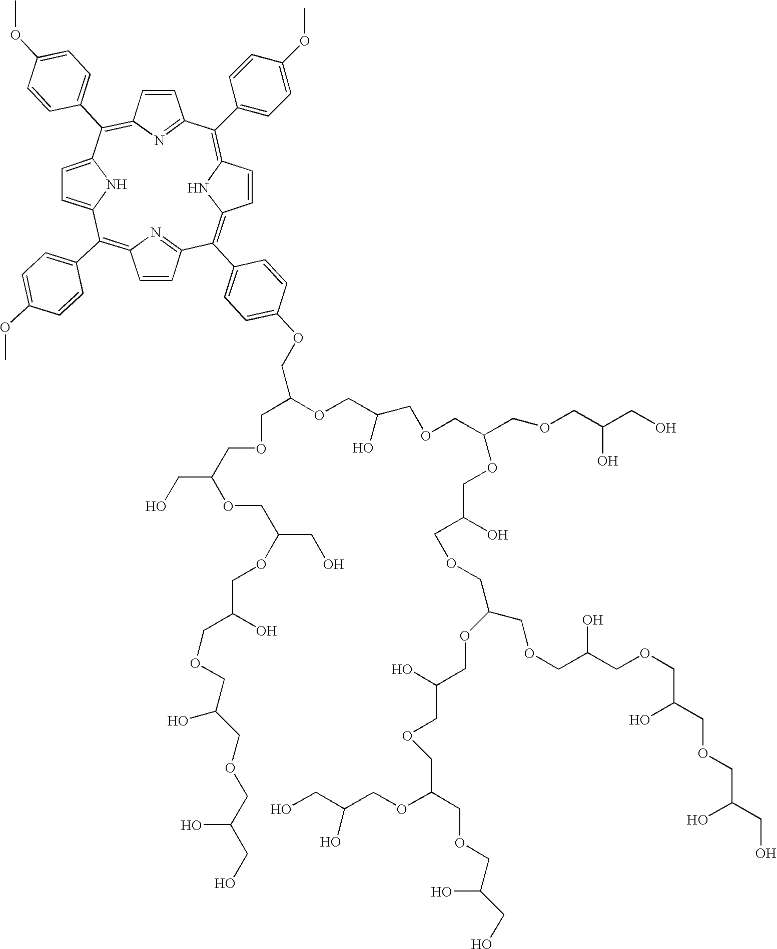

Especially useful polymers in accordance with the invention are those in which the porphyrin moiety is metalated, preferably with an Fe(II) ion. The metalation can be carried out using iron salts, for example, ferrous chloride or ferrous bromide. Preferred embodiments of such polymers, in the presence of an axial ligand, are capable of mimicking the oxygen binding properties of blood and can be used as haemoglobin replacements. A wide range of axial ligands can be used in this aspect of the invention including nitrogen donor ligands such as, for example, pyridines, imidazoles and histidines. A particularly preferred donor ligand is 1,2-dimethylimidazole, The axial ligand is preferably present during the metalation step in order to stabilise the porphyrin complex.

Solutions of such polymers in a physiologically compatible fluid can also be used as synthetic blood products and as blood substitutes, for example, in emergency treatments.

Other embodiments of hyperbranched polymers according to the invention can be used as catalysts and in photodynamic therapy.

The invention is illustrated by the following non-limitative Example:

### EXAMPLE

Synthesis of Porphyrin Centred Hyperbranched Polyglycerol.

The reaction was carried out in accordance with reaction scheme 1. Polymerization was carried out in a round bottomed flask equipped with a magnetic stirrer bar and a reflux condenser (under a nitrogen atmosphere). Tetraphenol porphyrin (1) (1.0 g, 1.48 mmol) in tetrahydrofuran (15 ml) was deprotonated using sodium hydride (0.071 g, 2.9 mmol). A 15 mL solution of glycidol (5.46 g, 80 mmol) in ethylene glycol dimethyl ether was then added at 65 C over 12 hours via a syringe pump. The THF was then removed under vacuum to leave a red paste at the bottom of the flask. The excess ethylene glycol dimethyl ether was then decanted off and the crude product dissolved in methanol and twice precipitated into acetone. After drying (15 h, 80 C, under vacuum), porphyrin centred polyglycerol was obtained as a red highly viscous paste in 45% yield (no trace of monomer or porphyrin could be detected by GPC). δ_{H} (250 MHz, D₂O): 7.38(d(b), Ph-H), 6.95(d(b), Ph-H), 6.62(s(b), β-H) 4.91(s, OH), 4.05-3.15(m, CH and CH₂). GPC (water; pH 7.4), Mn 6507, Mw 7960 (DP˜80). UV:λₘₐₓ 418 nm.

The solubility of the porphyrin centred hyperbranched polyglcerol in water was 100 mg/ml measured at 24° C.

Synthesis of Fe(II)—1,2-dimethylimidazole Porphyrin Centred Hyperbranched Polyglycerol.

The porphyrin centred hyperbranched polyglycerol can be metalated by refluxing the polymer with FeBr₂ and pyridine in methanol as a solvent. The resultant Fe(III) porphyrin centred hyperbranched polyglycerol is reduced by reaction with an sodium dithionite Na₂S₂O₄. In order to produce an oxygen binding polymer, the reduction is preferably carried out in the presence of the axial ligand 1,2-dimethylimidazole.

Measurement of Reversible O₂ Binding

The ability of the Fe(II) centred hyperbranched polymers (HBP) of the invention to bind oxygen can be demonstrated as follows:

The experiments are carried out using water (degassed) as solvent, in a quartz UV cuvette (1 cm path length) fitted with a suba seal. Oxygen is then bubbled through a solution of Fe(II) centred HBP containing a four fold excess of the axial ligand 1,2-dimethylimidazole for 1 minute. A UV spectrum of the solution is then measured and a clear and characteristic shift in the Soret band of the porphyrin is observed (i.e. from Fe(II) to the Fe(II)/O₂ complex). The position of the Soret band returns to the peak corresponding to Fe(II) after bubbling nitrogen through the same solution for 5 minutes. This procedure (O₂ followed by N₂) is then repeated 4 times, clearly demonstrating that the Fe(II) HBP is capable of reversibly binding O₂. With successive cycles (O₂ followed by N₂) irreversible oxidation begins to occur, as characterised by a peak corresponding to Fe(III) which begins to appear in the spectrum.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A water-soluble hyperbranched polymer comprising a porphyrin moiety and one or more hyperbranched polymer chains covalently bound thereto.

2. A polymer according to claim 1, wherein the porphyrin moiety is a focal core of the polymer and is surrounded by up to four hyperbranched polymer chains covalently bound thereto.

3. A polymer according to claim 1, having the structure of Formula 3:
P(HB)ₙ (3)
where P is a porphyrin moiety as hereinafter defined, HB is a hyperbranched polymer chain and n is an integer of from 1 to 4.

4. A polymer according to claim 1, wherein the hyperbranched polymer is soluble in water at least to the extent of 1 g/l.

5. A polymer according to claim 1, wherein the hyperbranched polymer is provided with solubilizing substituents in the polymer chains.

6. A polymer according to claim 5, wherein the solubilizing substituent is selected from hydroxyl groups, amine groups, acid groups, and quaternary ammonium groups.

7. A polymer according to claim 5, wherein the solubilizing substituents are derived from the monomeric component(s) of the hyperbranched polymer chains.

8. A polymer according to claim 1, wherein the hyperbranched polymer chains are selected from polyethers, polyesters or polyamides.

9. A polymer according to claim 8, wherein the hyperbranched polymer chains are selected from the group consisting of polyglycerols and other hydroxyl-substituted polyethers.

10. A polymer according to claim 1, wherein the hyperbranched polymer chains covalently linked to the porphyrin moiety are of a size, shape and number sufficient to provide a hydrophobic region around the porphyrin moiety, to protect and isolate the porphyrin moiety.

11. A polymer according to claim 10, wherein there are four hyperbranched polymer chains covalently linked to the porphyrin moiety.

12. A polymer according to claim 1, wherein the hyperbranched polymer has a molecular weight within the range of from 2000 to 24000.

13. A polymer according to claim 1, wherein the hyperbranched polymer has a polydispersity of from 1.1 to 3.0.

14. A polymer according to claim 1, wherein the porphyrin moiety is selected from the group consisting of porphyrin; alkyl substituted porphyrins; aryl substituted porphyrins; metalated derivatives of porphyrin; chlorins; bacteriochlorins; corrins; and corroles.

15. A polymer according to claim 14, wherein the porphyrin moiety is an iron(II) protoporphyrin-IX complex.

16. A process for the production of a water-soluble hyperbranched polymer comprising one or more porphyrin moieties, which process comprises subjecting an AB₂ monomer to a polymerisation reaction in the presence of a polymerisation initiator selected from the group consisting of functionalised porphyrin and porphyrin derivatives as a core.

17. A process according to claim 16, wherein the hyperbranched polymer is a polyether and the AB₂ monomer is selected from the group consisting of 2-(bromomethyl)-2-methylpropane-1,3-diol and simple derivatives thereof.

18. A process according to claim 16, wherein the hyperbranched polymer is a polyester and the AB₂ monomer is selected from the group consisting of 4-(2-hydroxyethyl)-ε-caprolactone, 2,2-bis(hydroxymethyl)butanoic acid and 3-hydroxy-2-(hydroxymethyl)-2-methylpropanoic acid.

19. A process according to claim 16, wherein the polymer is derived from a latent AB₂ monomer, wherein the monomer polymerises by ring opening polymerisation.

20. A process according to claim 19, wherein the latent AB₂ monomer is selected from the group consisting of glycidol(2,3-epoxy-I-propanol), 2,3-epoxy-I-butanol, 2,3-epoxy-I-pentanol, and 4-(2-hydroxyethyl)-ε-caprolactone.

21. A process according to claim 16, wherein the functionalised porphyrin or porphyrin derivative comprises functional groups selected from the group consisting of hydroxyalkyl groups, hydroxyaryl groups, acid groups, amine groups, epoxy groups and ester groups.

22. A process according to claim 16, wherein the functionalised porphyrin or porphyrin-derivative is a 5, 10, 15, 20-substituted porphyrin.

23. A process according to claim 22, wherein the functionalised porphyrin or porphyrin derivative is 5, 10, 15, 20-tetraphenol porphyrin.

24. A process according to claim 16, wherein the functionalised porphyrin or porphyrin derivative is activated by reaction with a deprotonating agent.

25. A process according to claim 16, wherein a functionalised porphyrin or derivative is reacted with an AB₂ monomer under polymerisation conditions such that the AB₂ monomer polymerises to form hyperbranched polymer chains radiating from the porphyrin moiety which occupies the centre or core of the growing polymer molecule.

26. A process according to claim 16, which is carried out under reflux in an organic solvent, at a temperature of from 40 to 180° C.

27. A water-soluble hyperbranched polymer comprising a porphyrin moiety having a metal ion inserted therein.

28. A water-soluble hyperbranched polymer according to claim 27, wherein the metal ion is an Fe (II) ion.

29. A water-soluble hyperbranched polymer according to claim 27, wherein the polymer is a polymer as claimed in claim 1.

30. A water-soluble hyperbranched polymer according to claim 27, wherein the metal ion is associated with an axial ligand.

31. A water-soluble hyperbranched polymer according to claim 30, wherein the axial ligand is a nitrogen donor ligand.

32. A water-soluble hyperbranched polymer according to claim 31, wherein the axial ligand is selected from the group consisting of pyridines, imidazoles and histidines.

33. A water-soluble hyperbranched polymer according to claim 30, wherein the axial ligand is 1,2-dimethylimidazole.

34. A water-soluble hyperbranched polymer according to claim 27, which is capable of reversibly binding oxygen thereto.

35. A water-soluble hyperbranched polymer capable of reversibly binding oxygen thereto.

36. A process for the production of a polymer according to claim 27, wherein a polymer according to claim 1 is reacted with a metal salt.

37. A process according to claim 36, wherein the metal salt is a ferrous salt.

38. A process according to claim 36, wherein the reaction takes place in the presence of an axial ligand.

39. A process according to claim 38, wherein the axial ligand is 1,2-dimethylimidazole.

40. A synthetic blood product or blood substitute, which comprises an aqueous solution of a water-soluble hyperbranched polymer comprising a porphyrin moiety having an Fe (II) atom inserted therein capable of reversibly binding oxygen thereto.

41. A synthetic blood product according to claim 40, wherein the hyperbranched polymer is a polymer as claimed in claim 27.

42. Use of a polymer as claimed in claim 35 as a replacement for haemoglobin.

43. Use of a polymer according to claim 1 as a catalyst or in photodynamic therapy.
